(19) United States
(12) Patent Application Publication
(10) Pub. No.: US 2012/0193974 A1
(43) Pub. Date: Aug. 2, 2012

(54) BRAKING SYSTEM FOR A VEHICLE

(76) Inventor: Andreas Birkheim, Kornwestheim (DE)

(21) Appl. No.: 13/194,072

(22) Filed: Jul. 29, 2011

(30) Foreign Application Priority Data
Aug. 11, 2010 (DE) 10 2010 039 186.7

(51) Int. Cl. B60T 13/58; B60T 13/14; B60T 13/66; B60T 13/128; B60T 13/16; B60T 8/40

(52) U.S. Cl. 303/10; 303/116.1

(57) ABSTRACT

A braking system is described for a vehicle, including: a master brake cylinder having at least one chamber, which is hydraulically connected to at least one wheel brake cylinder for braking a wheel of the vehicle; a hydraulic actuating device, which actuates a piston of the master brake cylinder in order to thereby pressurize hydraulic fluid in the chamber; an accumulator, which stores hydraulic fluid under pressure and supplies it to the actuating device for actuating the piston of the master brake cylinder; and a pump, which, in a first operating mode of the braking system, conveys hydraulic fluid from a tank to the accumulator and, in a second operating mode of the braking system, pumps hydraulic fluid from the wheel brake cylinder to the master brake cylinder.

### RELATED APPLICATION INFORMATION

The present application claims priority to and the benefit of German patent application no. 10 2010 039 186.7, which was filed in Germany on Aug. 11, 2010, the disclosure of which is incorporated herein by reference.

### FIELD OF THE INVENTION

The present invention relates to a braking system for a vehicle.

### BACKGROUND INFORMATION

Braking systems for vehicles are generally divided into so-called non-muscular-energy braking systems and energy-assisted braking systems.

In non-muscular-energy braking systems, to pressurize the wheel brake cylinders, the master brake cylinder, which is hydraulically connected to the wheel brake cylinders, is actuated by hydraulic fluid, without direct transmission of the foot force of the driver to the master brake cylinder. Such a non-muscular-energy braking system is discussed, for example, in DE 10 2004 025 638 A1.

In contrast to that, in energy-assisted braking systems, a brake booster is used, which acts upon the master brake cylinder in addition to the foot force of the driver, in order to pressurize the wheel brake cylinders with hydraulic fluid. Such an energy-assisted braking system is discussed, for example, in DE 103 18 850 A1.

### SUMMARY OF THE INVENTION

In comparison with the conventional design approaches, the braking system described herein offers the advantage that since, in the first operating mode of the braking system, the pump conveys hydraulic fluid from the tank to the accumulator, and since, in the second operating mode of the braking system, the pump pumps hydraulic fluid from the wheel brake cylinder to the master brake cylinder, the pump is assigned a dual function.

Ordinarily, known braking systems already have a pump that pumps hydraulic fluid from the wheel brake cylinders to the master brake cylinder. According to the exemplary embodiments and/or exemplary methods of the present invention, this pump shall now also be used for filling the accumulator with hydraulic fluid from the tank. Consequently, one may dispense with providing an additional pump, which would be necessary, in itself, for filling the accumulator with hydraulic fluid from the tank, or a corresponding, additional pump may be sized to be smaller.

The features indicated in the respective descriptions herein relate to advantageous refinements and improvements of the subject matter of the exemplary embodiments and/or exemplary methods of the present invention.

Exemplary embodiments of the present invention are shown in the drawings and explained in greater detail in the following description.

### BRIEF DESCRIPTION OF THE DRAWINGS

FIG. 1 shows, in schematic form, a braking system according to an exemplary embodiment of the present invention.

FIG. 2 shows, in a perspective view, the actuating device and the piston accumulator from FIG. 1.

FIG. 3 shows, in schematic form, an arrangement, alternative to that of FIG. 1, of the actuating device and the accumulator with respect to one another.

FIG. 4 shows, in schematic form, an embodiment, alternative to that of FIG. 1, of the first and second units.

FIG. 5 shows, in schematic form, an embodiment alternative to that of FIG. 1, having an additional pump.

FIG. 6 shows, in schematic form, an embodiment alternative to that of FIG. 1; the 2/2-way directional control valves, which form the intake and discharge valves of the actuating device, being replaced with a 3/3-way directional control valve.

FIG. 7 shows, in schematic form, an embodiment alternative to that of FIG. 1; the non-return valves, which hydraulically connect the suction side of the pump to the tank and the delivery side of the pump to the master brake cylinder, each being replaced with a 2/2-way directional control valve.

FIG. 8 shows, in schematic form, an embodiment alternative to that of FIG. 1; the two non-return valves, which hydraulically connect the suction side of the pump to the tank and the delivery side of the pump to the master brake cylinder, being replaced with a 4/2-way directional control valve.

FIG. 9 shows, in schematic form, an embodiment alternative to that of FIG. 1; the accumulator taking the form of a metallic expansion-bellows accumulator, and the first and second units being combined.

### DETAILED DESCRIPTION

In the figures, like or functionally corresponding elements are denoted by like reference numerals, provided that nothing is indicated to the contrary.

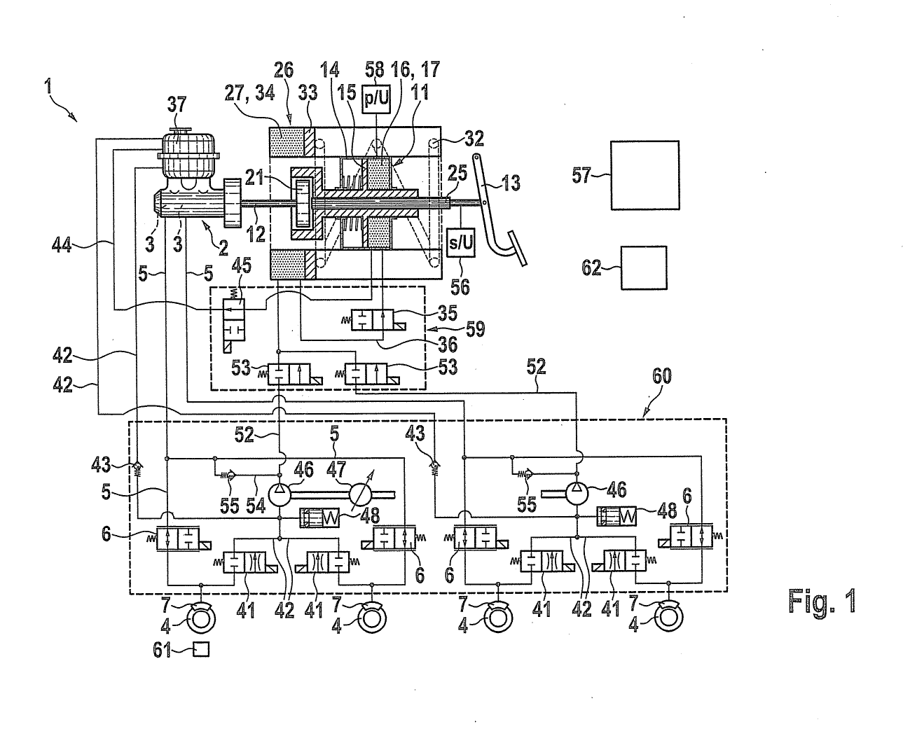

FIG. 1 schematically shows a braking system 1 according to an exemplary embodiment of the present invention.

Braking system 1 may be used in a motor vehicle not described any further.

Braking system 1 has a master brake cylinder 2 having two indicated chambers 3, which are each hydraulically connected, via lines 5, to two wheel brake cylinders 7 for braking wheels 4 of the motor vehicle. Each of lines 5 is connected to a wheel brake cylinder 7 via an intake valve 6. Intake valves 6 may take the form of 2/2-way directional control valves, which are open in a de-energized state. Each of lines 5 may be branched, in order to supply two wheel brake cylinders 7 with hydraulic fluid. Master brake cylinder 2 may be a tandem master cylinder (TMC).

Braking system 1 further has a hydraulic actuating device 11, which actuates a piston 12 of master brake cylinder 2 in order to thereby force hydraulic fluid into chambers 3. In this instance, hydraulic actuating device 11 takes the form of a brake booster, which boosts a foot force applied by the driver of the motor vehicle to piston 12 via a pedal 13. Accordingly, this is an energy-assisted braking system. However, it is equally conceivable to configure actuating device 11 as a non-muscular-energy braking system.

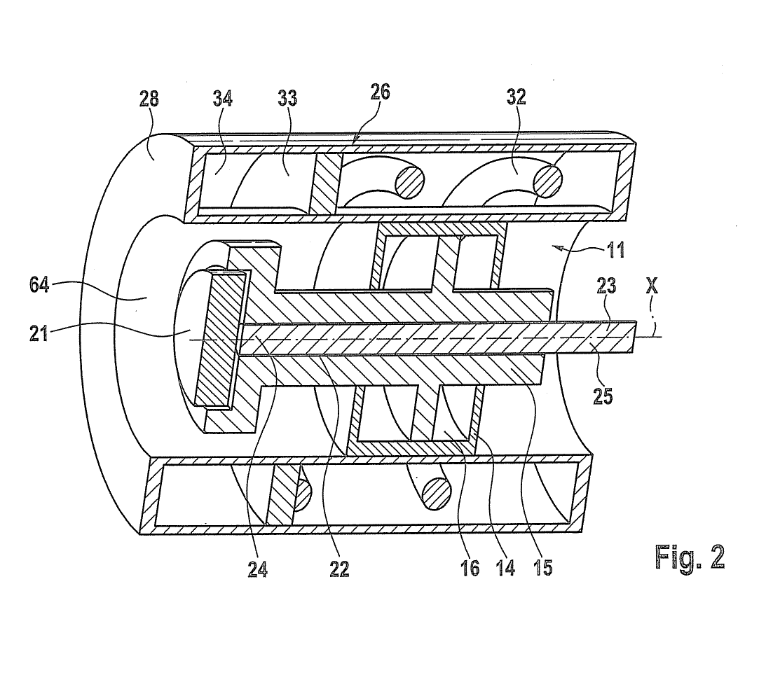

Hydraulic actuating device 11 is shown in further detail in a perspective view in FIG. 2. Actuating device 11 has a cylinder 14, in which a piston 15 is guided. A chamber 16 formed between cylinder 14 and piston 15 is acted upon by hydraulic fluid 17, cf. FIG. 1, whereby piston 15 is displaced in its longitudinal direction X and acts upon piston 12 of master brake cylinder 2 via a reaction disk 21. A pedal rod 23, which also acts upon reaction disk 21 at its one end 24 and is coupled to pedal 13 at its other end 25, extends through a passage 22 in piston 15, the passage being co-axial with longitudinal direction X. Consequently, the driver may apply a force to piston 12 of master brake cylinder 2 independently of actuating device 11, through which wheel brake cylinder 7 is actuated. This is particularly advantageous in view of a possible failure of actuating device 11.

In addition, braking system 1 has an accumulator 26, which stores hydraulic fluid 27 under pressure and supplies it to actuating device 11 for actuating piston 12 of master brake cylinder 2.

Accumulator 26 is shown perspectively in FIG. 2. Accumulator 26 is formed as a piston accumulator. However, it is also conceivable to form this, for example, as a bladder-type accumulator, as is explained in even more detail at a later point.

Accumulator 26 has a cylinder 28 having an annular cross-section. A compression spring 32 is situated in the interior of cylinder 28, the compression spring pressing a separating piston 33 against hydraulic fluid 27 contained in a chamber 34 formed between cylinder 28 and separating piston 33. Chamber 34 of accumulator 26 is connected to chamber 17 of actuating device 11 via an intake valve 35, cf. FIG. 1, and a line 36. Intake valve 35 may take the form of a 2/2-way directional control valve, which is closed in a de-energized state.

As can be gathered from FIG. 2, actuating device 11, in particular, cylinder 14 and piston 15, is situated in an interior chamber 64 of cylinder 28 of accumulator 26; cylinder 28 surrounding actuating device 11 along longitudinal direction X.

Braking system 1 further includes a tank 37, cf. FIG. 1, which is hydraulically connected to wheel brake cylinders 7 via lines 42. Each of lines 42 is connected to wheel brake cylinders 7 via a discharge valve 41 and a valve 43. Discharge valves 41 may take the form of throttled 2/2-way directional control valves, which are closed in a de-energized state. Valves 43 take the form of non-return valves, but other embodiments are also conceivable, as is explained in even more detail at a later point. Each of lines 42 may be branched, in order to lead hydraulic fluid away from two wheel brake cylinders 7.

Tank 37 is also hydraulically connected to chamber 17 of actuating device 11 via a line 44 and a discharge valve 45. Discharge valve 45 may take the form of a 2/2-way directional control valve, as well.

Furthermore, braking system 1 has two pumps 46, which, in a first operating mode of braking system 1, convey hydraulic fluid from tank 37 to accumulator 26 and, in a second operating mode of braking system 1, pump hydraulic fluid from wheel brake cylinders 7 to master brake cylinder 2.

As long as nothing to the contrary is indicated, subsequent explanations relate only to the pump 46 shown on the left in FIG. 1, but are equally valid for the pump 46 shown on the right.

At its suction side, pump 46 is hydraulically connected to line 42, namely, between discharge valves 41 and valve 43. Pump 46 is driven by a driving device 47, for example, by an electric motor. In addition, there is the possibility of further connecting the suction side of pump 46 to a low-pressure accumulator 48, in which hydraulic fluid coming from discharge valves 41 may be stored.

On the delivery side, pump 46 is hydraulically connected to chamber 34 of accumulator 26 via a line 52 and an intake valve 53. Intake valve 53 may take the form of a 2/2-way directional control valve.

A line 54 connects to line 52 between pump 46 and intake valve 53, line 54 hydraulically connecting the delivery side of pump 46, via a valve 55, to line 5, and therefore to chamber 3 of master brake cylinder 2. Valve 55 takes the form of a non-return valve, but in this case, other embodiments are also conceivable, as is explained in even more detail at a later point.

Braking system 1 also has a first device 56 for detecting a driver braking signal. First device 56 is formed, for example, as a displacement sensor which detects manipulation of pedal 13 by the driver.

If first device 56 does not detect a driver braking signal, then braking system 1 is in the mentioned, first operating mode. In this first operating mode, wheel brake cylinders 7 are not actuated, and discharge valves 41 are closed. In addition, if a control device 57 (electronic control unit) of braking system 1 determines that the pressure of hydraulic fluid 27 in accumulator 26 is below a first, predefined pressure, control device 57 switches pump 46 on, opens intake valve 53 and closes intake valve 35 (as long as this is not already closed). Thereupon, pump 46 pumps hydraulic fluid from tank 37, through valve 43, into chamber 34 of accumulator 26, until a second, predefined pressure is reached, whereupon control device 57 switches off pump 46. The pressure in chamber 34 of accumulator 27 may be measured by a pressure sensor 58. As an alternative, chamber 34 may be provided with a separate pressure sensor not shown. Valve 55 is set, such that it permits accumulator 26 to be filled without opening, i.e., without connecting the delivery side of pump 46 to chamber 3 of master brake cylinder 2.

Since braking system 1 is mostly in the first operating mode, pump 46 has a comparatively long period of time to fill accumulator 26. Therefore, pump 46 may be comparatively small. In particular, the ABS/ESP pump that is conventionally already installed may be used as pump 46.

If first device 56 detects a driver braking signal, intake valve 53 is closed, and the position of intake valve 35 is controlled by control device 57 as a function of the driver braking signal and the pressure in chamber 16. If intake valve 35 is at least partially open, then hydraulic fluid flows from chamber 34 of accumulator 26 into chamber 16 of actuating device 17. Then, piston 15 of actuating device 11 presses on piston 12 of master brake cylinder 2 and consequently increases the force applied to piston 12 by the driver. Thus, hydraulic fluid flows out of chambers 3 of master brake cylinder 2, through open intake valve 6, into wheel brake cylinders 7, which then brake wheels 4. Discharge valves 41 are closed.

Braking system 1 also has a second device 61 for detecting locking of one or more of the wheels 4. Second device 61 takes the form of, e.g., a speed sensor and is part of an anti-lock braking system (ABS).

Now, if first device 56 detects a driver braking signal and second device 61 detects locking of a wheel 7, then braking system 1 is in the mentioned, second operating mode. In the second operating mode, control device 57 partially opens the discharge valve 41 assigned to the locking wheel 4, so that the locking of wheel 4 is stopped. As a result, hydraulic fluid flows rapidly from corresponding wheel brake cylinder 7 into low-pressure accumulator 48. At the same time, control device 57 closes intake valve 53 and switches pump 46 on, which then pumps the hydraulic fluid out of low-pressure accumulator 48, through valve 55, back to chamber 3 of master brake cylinder 2. Accordingly, the second operating mode is an anti-lock mode of braking system 1.

Furthermore, braking system 1 may have a third device 62 for controlling driver-independent braking. Third device 62 may take the form of a microprocessor and be integrated in control device 57. Third device 62 may also have additional devices, for example, a distance sensor for measuring a distance to the next vehicle, etc. Third device 62 may be part of a system for controlling operating dynamics (electronic stability program) and/or a system for controlling the distance to a vehicle driving ahead or the like.

If third device 62 is activated, for example, by the driver, it controls braking of the motor vehicle when certain conditions are fulfilled, e.g., when the distance to the next vehicle falls below a predefined value. Braking system 1 is then in a third operating mode. A driver braking signal may have been generated, but does not have to have been generated.

In the third operating mode, actuating device 11 actuates master brake cylinder 2, which consequently pressurizes one or more wheel brake cylinders 7 with hydraulic fluid. To this end, third device 62 closes intake valve 53 (if open) and opens intake valve 35, in order to thereby pressurize chamber 17 of actuating device 11 with hydraulic fluid from chamber 34 of accumulator 26. As a result, piston 12 of the master brake cylinder is acted upon by a force. In this case, a pedal force from the driver is not necessary. Thereupon, hydraulic fluid flows from chambers 3 of master brake cylinder, through open intake valve 6 and into wheel brake cylinder 7, through which wheels 4 are braked.

Valves 35, 45, 53, together with corresponding lines 36, 44, 52, may be physically combined in a first unit 59, e.g., in a control block.

In addition, valves 6, 41, 43 and 55, together with corresponding lines 5, 42, 52, 54, as well as pumps 46, low-pressure accumulator 48 and driving device 47, may be physically combined to form a second unit 60, e.g., in a modulation block.

First and second units 59, 60 may each have, for example, a base block made of aluminum, in which the respective components, i.e., valves, lines, pumps, accumulator and driving device, are situated.

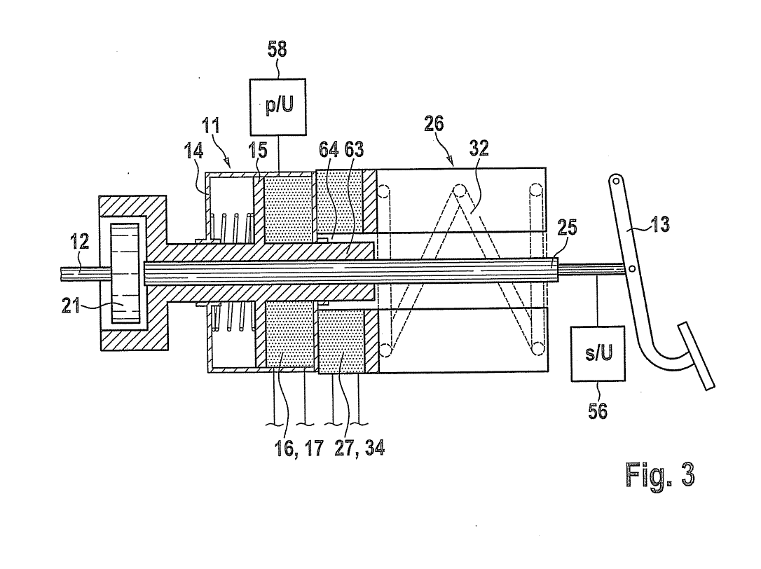

FIG. 3 schematically shows an arrangement, alternative to that of FIG. 1, of actuating device 11 and accumulator 26 with respect to one another.

In the exemplary embodiment, actuating device 11 and accumulator 26 are positioned coaxially, one behind the other; only the one end 63 of piston 15 extending into the space 64 surrounded by cylinder 28 of accumulator 26.

In all other aspects, there is agreement between the exemplary embodiments according to FIGS. 1 and 3.

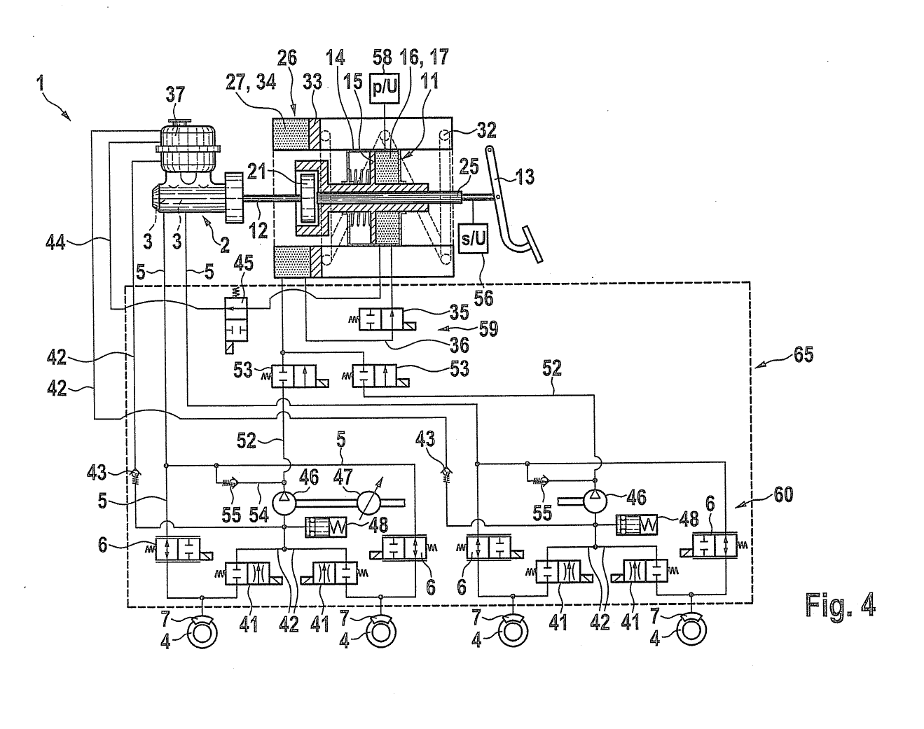

FIG. 4 schematically shows an embodiment, alternative to that of FIG. 1, of first and second units 59, 60.

According to the exemplary embodiment of FIG. 4, units 59 and 60 from FIG. 1 are physically combined to form a single unit 65. For example, units 59 and 60 may be integrated into a single base block, in particular, one made of aluminum.

In all other aspects, there is agreement between the exemplary embodiments according to FIGS. 1 and 4.

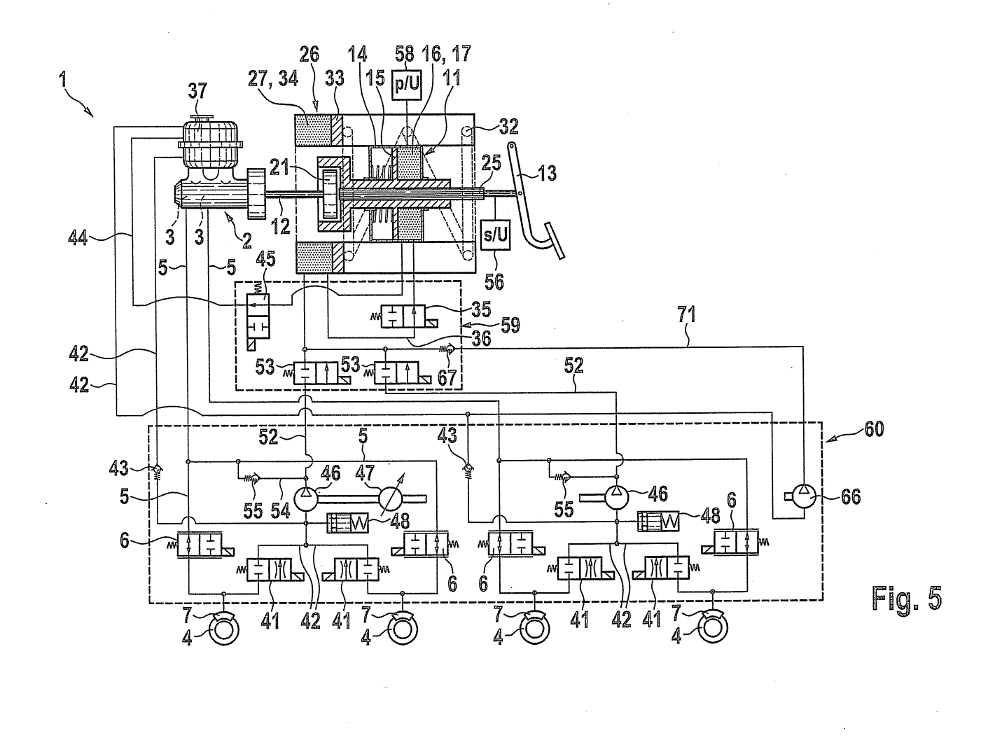

FIG. 5 schematically shows, in comparison to FIG. 1, an alternative embodiment having an additional pump 66.

For the case in which pumps 46 have an output that is too low, e.g., when ABS pumps already present in the vehicle are supposed to serve as pumps 46, an additional pump 66 may be provided, which pressurizes accumulator 26 with hydraulic fluid. Pump 66 is connected to tank 37 on its suction side, and is connected, on its delivery side, to chamber 34 of accumulator 26 via a valve 67 and a line 71. Valve 67 may take the form of a non-return valve.

In all other aspects, there is agreement between the exemplary embodiments according to FIGS. 1 and 5.

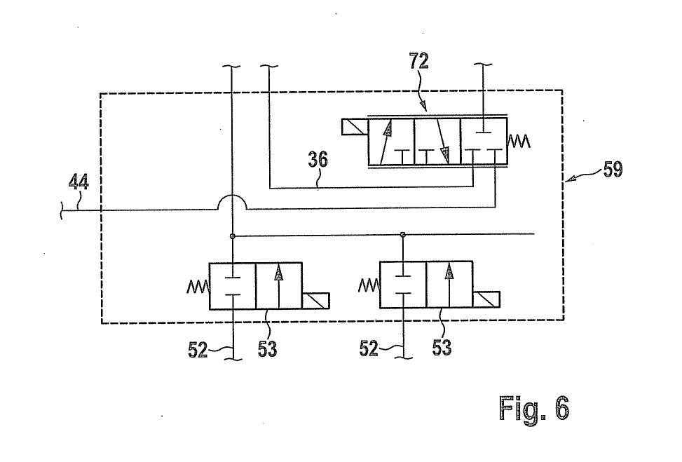

FIG. 6 schematically shows an embodiment alternative to that of FIG. 1; the 2/2-way directional control valves in FIG. 1, which intake valve 35 and discharge valve 45 constitute, being replaced with a 3/3-way directional control valve 72. The 3/3-way directional control valve 72 alternatively connects chamber 17 of actuating device 11 to chamber 34 of accumulator 26, or connects chamber 17 to tank 37.

In all other aspects, there is agreement between the exemplary embodiments according to FIGS. 1 and 6.

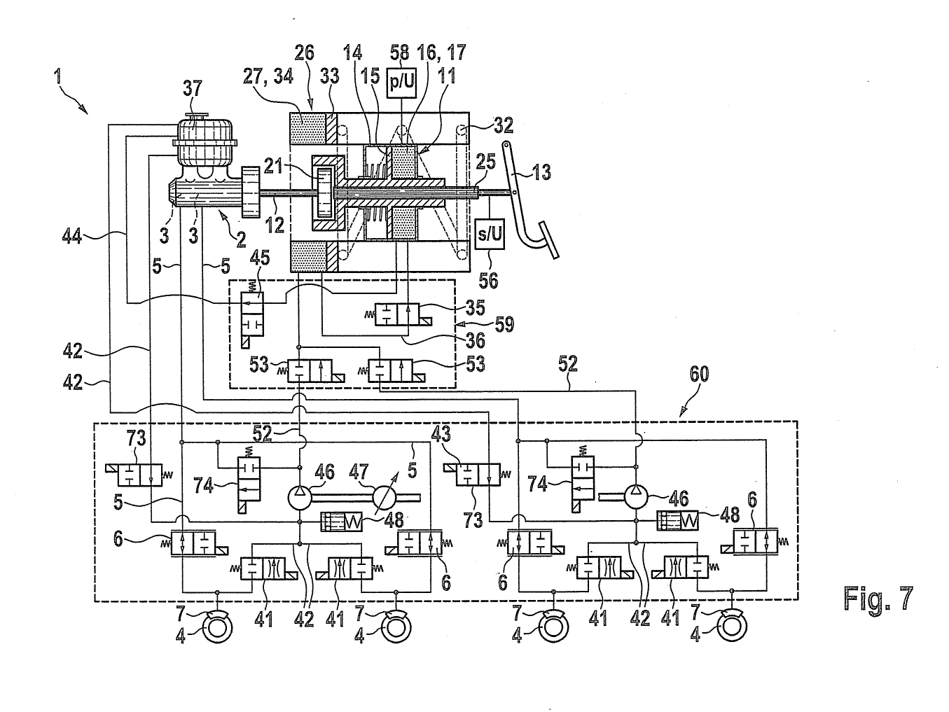

FIG. 7 schematically shows an embodiment alternative to that of FIG. 1; the two non-return valves 43, 55 in FIG. 1, which hydraulically connect the suction side of pump 46 to tank 37 and the delivery side of pump 46 to master brake cylinder 2, being replaced with 2/2-way directional control valves 73, 74. In comparison with non-return valves 43, 55 from FIG. 1, 2/2-way directional control valves 73, 74 have the advantage that they may be controlled in a precise and simple manner.

In all other aspects, there is agreement between the exemplary embodiments according to FIGS. 1 and 7.

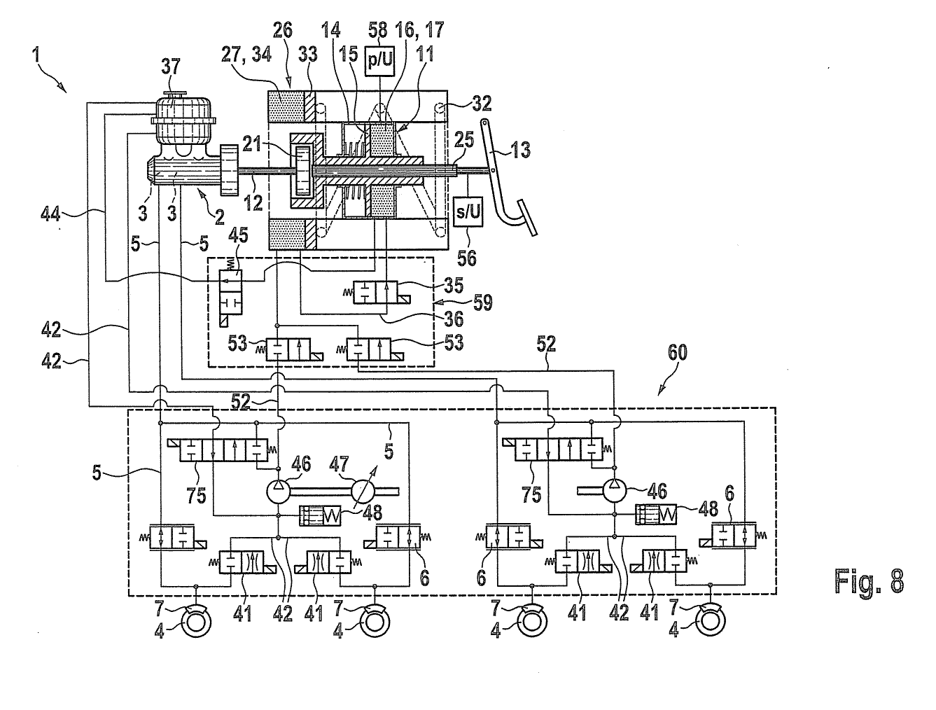

FIG. 8 schematically shows an embodiment alternative to that of FIG. 1; the two non-return valves 43, 53, which hydraulically connect the suction side of pump 46 to tank 37 and the delivery side of pump 46 to master brake cylinder 2, being replaced with a 4/2-way directional control valve 75. In comparison with non-return valves 43, 55 from FIG. 1, 4/2-way directional control valve 75 has the advantage that it may be controlled in a precise and simple manner. Combining non-return valves 43, 53 in the one 4/2-way directional control valve 75 is also possible, since non-return valves 43 and 53 are always actuated simultaneously.

In all other aspects, there is agreement between the exemplary embodiments according to FIGS. 1 and 8.

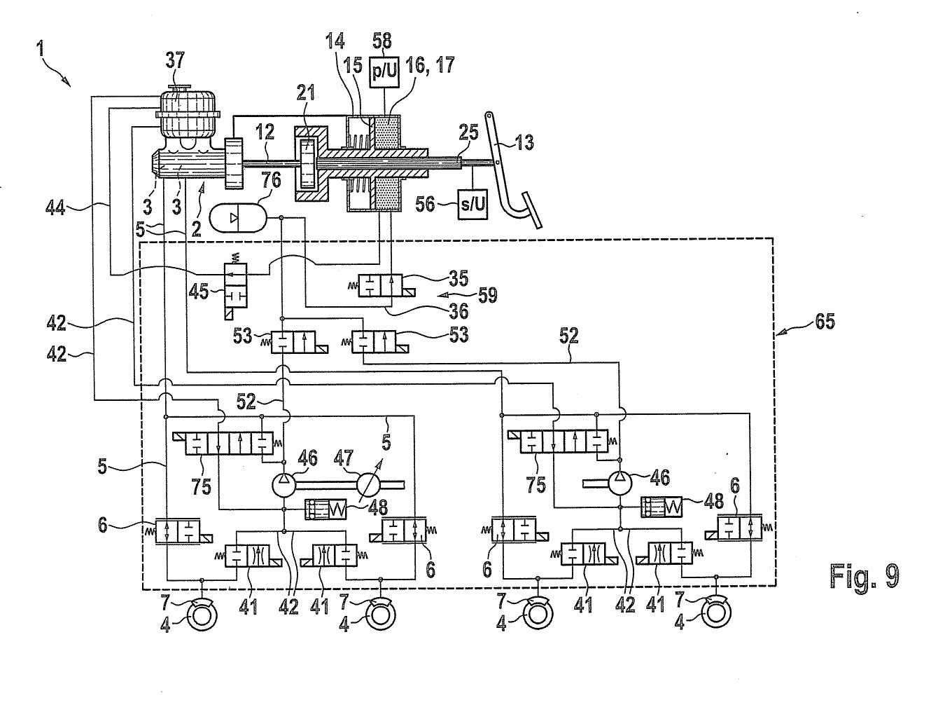

FIG. 9 schematically shows an embodiment alternative to that of FIG. 1; accumulator 26 from FIG. 1 being formed by a metallic expansion-bellows accumulator 76. Metallic expansion-bellows accumulator 76 is provided separate from actuating device 11. Alternatively, accumulator 26 may take the form of a bladder accumulator or another diaphragm accumulator.

In addition, in the exemplary embodiment according to FIG. 9, first and second units 59 and 60 from FIG. 1 are combined to form a unit 65, as already explained in connection with FIG. 4. Furthermore, the 4/2-way directional control valve 75 explained in connection with FIG. 8 is provided.

In all other aspects, there is agreement between the exemplary embodiments according to FIGS. 1 and 9.

Although the exemplary embodiments and/or exemplary methods of the present invention were specifically described above with reference to exemplary embodiments, it is not limited thereto, but may be modified in many ways. In addition, it shall be pointed out that the word “a” or “an” does not rule out a plurality.

What is claimed is:

1. A braking system for a vehicle, including:
a master brake cylinder having at least one chamber, which is hydraulically connected to at least one wheel brake cylinder for braking a wheel of the vehicle;
a hydraulic actuating device, which actuates a piston of the master brake cylinder to pressurize hydraulic fluid in the chamber;
an accumulator, which stores hydraulic fluid under pressure and supplies it to the actuating device for actuating the piston of the master brake cylinder; and
a pump, which, in a first operating mode of the braking system, conveys hydraulic fluid from a tank to the accumulator and, in a second operating mode of the braking system, pumps hydraulic fluid from the wheel brake cylinder to the master brake cylinder.

2. The braking system of claim 1, further comprising:
a first device for detecting a driver braking signal and a second device for detecting locking of the wheel, wherein when the first device does not detect a driver braking signal, the braking system is in the first operating mode, and wherein when the first device detects a driver braking signal and the second device detects locking of the wheel, the braking system is in the second operating mode.

3. The braking system of claim 1, further comprising:
a third device for controlling driver-independent braking, wherein when the third device controls driver-independent braking, the braking system is in a third operating mode, in which the actuating device actuates the master brake cylinder and, consequently, the master brake cylinder pressurizes the wheel brake cylinder with hydraulic fluid.

4. The braking system of claim 1, wherein the hydraulic actuating device is a brake booster, which boosts a force applied mechanically by the driver to the piston of the master brake cylinder.

5. The braking system of claim 4, wherein the brake booster has a cylinder and a piston guided in it, wherein the piston is formed with a passage, through which a pedal rod extends, and wherein at least one of (i) at its one end, the pedal rod being actuable by the driver via a pedal), and (ii) at its other end, the pedal rod acting upon the piston of the master brake cylinder.

6. The braking system of claim 5, wherein at its other end, the pedal rod acts upon the piston of the master brake cylinder via a reaction disk.

7. The braking system of claim 1, wherein the accumulator includes a piston accumulator, and the piston accumulator is annular and accommodates at least a section of at least the brake booster in its interior.

8. The braking system of claim 1, wherein on its suction side, the pump is connected to the wheel brake cylinder, the tank and a low-pressure accumulator, wherein a first valve is situated between the pump and the tank, and wherein the first valve prevents a flow of hydraulic fluid from the low-pressure accumulator to the tank.

9. The braking system of claim 1, wherein on its delivery side, the pump is connected to the accumulator and the master brake cylinder, wherein a second valve is situated between the pump and the master brake cylinder, and wherein the second valve prevents hydraulic fluid from flowing into the master brake cylinder when the hydraulic fluid is supplied to the accumulator.

10. The braking system of claim 1, further comprising:
a further pump, which pumps hydraulic fluid from the tank into the accumulator.
